(19) United States
(12) Patent Application Publication
(10) Pub. No.: US 2007/0067222 A1
(43) Pub. Date: Mar. 22, 2007

(54) System and methods for tracking consumers in a store environment

(76) Inventors: Ronald Gary Godsey, Baltimore, MD (US); Marshall P. Haine, Reistertown, MD (US); Mary Elizabeth Scheid, Rotterdam (NL)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/602,423

(22) Filed: Nov. 20, 2006

Related U.S. Application Data
(63) Continuation of application No. 09/935,774, filed on Aug. 22, 2001.
(60) Provisional application No. 60/228,909, filed on Aug. 29, 2000.

(51) Int. Cl. G06Q 30/00

(52) U.S. Cl. 705/23

(57) ABSTRACT

A virtual store environment is provided.

### CROSS REFERENCE TO RELATED APPLICATION

This application is a divisional of application Ser. No. 09/935774, filed Aug. 22, 2001, which claims the benefit of application Ser. No. 60/228,909 filed Aug. 29, 2000.

### BACKGROUND OF THE INVENTION

The present invention relates generally to tracking systems. More specifically, the present invention provides empirical tools for gathering data regarding consumer behavior in store environments and for analyzing that data to understand how different stimuli affect the behavior.

There is tremendous economic incentive for both retailers of goods and the providers of such goods to understand what motivates consumers to purchase. In a typical supermarket there are a wide variety of tools and strategies for enhancing the likelihood that consumers will purchase specific products. However, the effectiveness of these various tools and techniques is not always well understood. That is, there is currently a lack of empirical techniques with which the effectiveness of these tools may be evaluated.

One way of doing this is to evaluate point-of-sale data to determine how many units of a particular product are purchased when new signage for that product is placed. Unfortunately, it is difficult to isolate the effect of the signage from other factors, especially where the products are offered in multiple places in the stores.

Another method involves the manual recordation of consumer traffic using human monitors or video cameras to generate anecdotal evidence upon which recommendations for store environment modifications are then based. These recommendations are typically based on the qualitative insights and experience of the evaluators. An example of such an evaluation involves the “butt-brush” factor coined by Paco Underhill (see www.envirosell.com) which relates to the fact that if there is not sufficient room in a product area to maneuver without coming into physical contact with another shopper, individuals are less likely to purchase the products in that area. Unfortunately, this kind of low tech approach cannot generate sufficient data to do the kind of analysis which can determine the specific effects of specific store environment parameters.

In view of the foregoing, there is a need for empirical tools which can allow detailed analysis of what consumers experience in stores; where they go, how long they stay there, and what influences the paths they choose.

### SUMMARY OF THE INVENTION

According to the present invention, empirical tools are provided which enable detailed analysis and understanding of how various stimuli affect consumer behavior in a store environment. According to one embodiment, actual tracking of consumers in the store environment is effected, thus generating much more substantial information than simply tracking purchases or using qualitative interview techniques. According to various embodiments, this quantitative information may then be complemented with qualitative information, e.g., consumer interviews, with the end objective being improved utilization of store floor space. That is, this information may be used to effectively direct consumers to higher profit margin items, to understand how demos, end caps, and in-store multimedia presentations affect consumers.

According to a further embodiment, once enough data have been gathered, a store environment simulation is created with which the effects of various environment parameters (e.g., aisle configuration, demo placement, etc.) on consumer traffic are simulated. The sales and profit implications of these traffic patterns are then determined. The simulation environment is determined using statistical techniques such as, for example, regression analysis to identify how specific environment parameters influence traffic patterns. These data are then correlated with other data (e.g., point-of-sale data, product delivery data, inventory data, and product placement data) to determine a “coefficient” which represents the effect of the specific parameters on what consumers actually purchase.

Thus, the present invention provides a system for tracking a plurality of product containers in a store environment and generating a track through the store environment representative of a continuous path followed by each of the product containers to a point-of-sale location. The system includes the plurality of product containers and a plurality of identification tags each of which is associated with and uniquely identifies one of the product containers. A plurality of sensors is provided in the store environment each of which has a region associated therewith within which the identification tags are detected. At least one of the plurality of sensors has within its associated region the point-of-sale location. A processor is configured to receive location data from the plurality of sensors and generate the track therefrom.

Another embodiment of the present invention provides a computer-implemented method for determining effects of changing parameters in a store environment. A first plurality of tracks through the store environment is generated. Each of the first plurality of tracks is representative of a continuous path followed by each of a first plurality of product containers to a point-of-sale location before one or more store environment parameters is changed. A second plurality of tracks through the store environment is generated. Each of the second plurality of tracks is representative of a continuous path followed by each of a second plurality of product containers to a point-of-sale location after the one or more store environment parameters is changed. The first and second plurality of tracks are then analyzed to determine relationships between the one or more store environment parameters and one or more of the effects.

According to yet another embodiment, the present invention provides a computer-implemented method for simulating a store environment. The simulation employs consumer tracking data which includes first and second pluralities of tracks through a real store environment. Each of the first plurality of tracks is representative of a continuous path followed by each of a first plurality of product containers to a point-of-sale location before a plurality of real store parameters is changed. Each of the second plurality of tracks is representative of a continuous path followed by each of a second plurality of product containers to a point-of-sale location after the plurality of real store parameters is changed. A virtual store environment is presented having a plurality of virtual store parameters associated therewith corresponding to the real store parameters. The virtual store environment is characterized by virtual store effects which are determined using the virtual store parameters and relationships between the plurality of real store parameters and the plurality of real store effects, the relationships having been determined from analysis of the first and second plurality of tracks.

According to a still further embodiment, the present invention provides a computer-implemented method for generating tracks through a store environment, each track being representative of a continuous path followed by each of a plurality product containers. Location data for each of the plurality of product containers are collected using a plurality of sensors. Each track is generated from the location data only where the location data for the corresponding product container satisfies at least one validity criterion.

A further understanding of the nature and advantages of the present invention may be realized by reference to the remaining portions of the specification and the drawings.

### BRIEF DESCRIPTION OF THE DRAWINGS

FIG. 1 is a diagram of a system for tracking consumer movements in a store environment designed according to a specific embodiment of the present invention;

FIG. 2 is a flowchart illustrating the generation of tracking data according to a specific embodiment of the present invention;

FIG. 3 is a flowchart illustrating the use of tracking data to determine the effects of changing store environment parameters according to a specific embodiment of the present invention;

FIG. 4 is a flowchart illustrating the generation of a virtual store environment according to a specific embodiment of the present invention; and

FIGS. 5a and 5b are representations of two different virtual store environments.

### DETAILED DESCRIPTION OF SPECIFIC EMBODIMENTS

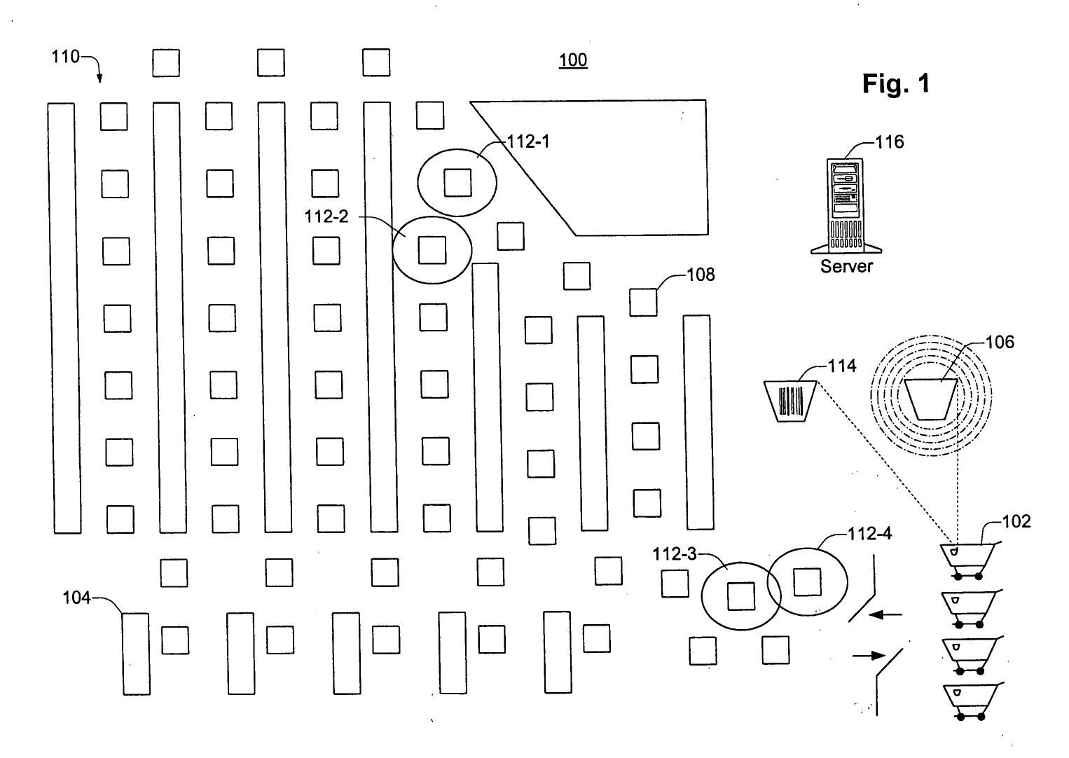

FIG. 1 is a diagram of a system 100 for tracking consumer movements in a store environment designed according to a specific embodiment of the present invention. The basic parameters measured by system 100 include where an individual goes (e.g., as indicated by location data corresponding to their shopping cart 102), and for how long. This may then be tied in with what that individual purchases based on the individual's corresponding check out or point-of-sale data gathered at check out stands 104. As will be understood, the point-of-sale data may be generated using any of a number of conventional techniques.

According to one embodiment, each of a plurality of shopping carts 102 has a radio frequency or infrared transmitter tag 106 about the size of a credit card and powered by an on-board battery (not shown). The transmissions from transmitter tags 106 are received by the nearest of a plurality of passive sensors 108 in the ceiling of the store. Ceiling sensors 108 are placed at regular intervals in aisles 110, e.g., every eight feet, and each corresponds to a specific grid location in the store. Each cart's transmitter 106 transmits a unique signal periodically, e.g., every 1.5 second.

According to various embodiments, the sensory ranges 112 of adjacent sensors 108 do not overlap such that only one sensor 108 “perceives” a cart 102 at a time. This is illustrated by non-overlapping sensory ranges 112-1 and 112-2. Alternatively, sensory ranges 112 of adjacent sensors 108 may overlap such that multiple sensors 108 perceive a cart 102 at a time. This is illustrated by overlapping sensory ranges 112-3 and 112-4. Various overlapping and non-overlapping schemes may be employed in various embodiments to provide an appropriate amount of floor coverage such that adequate location data are generated.

Moreover, it will be understood that the particulars of the embodiment shown in FIG. 1 are merely illustrative and that a wide variety of sensing technologies may be employed to provide the basic infrastructure for generating cart location data. For example, instead of having active transmitters associated with the carts, the carts could have passive tags 114, e.g., detectable patterns such as UPC codes (as shown), which may be scanned by active sensors situated around the store environment. Moreover, the sensors need not be located in the ceiling. Rather they may be placed anywhere in the store such as, for example, in the floor, integrated in shelving and store displays, etc.

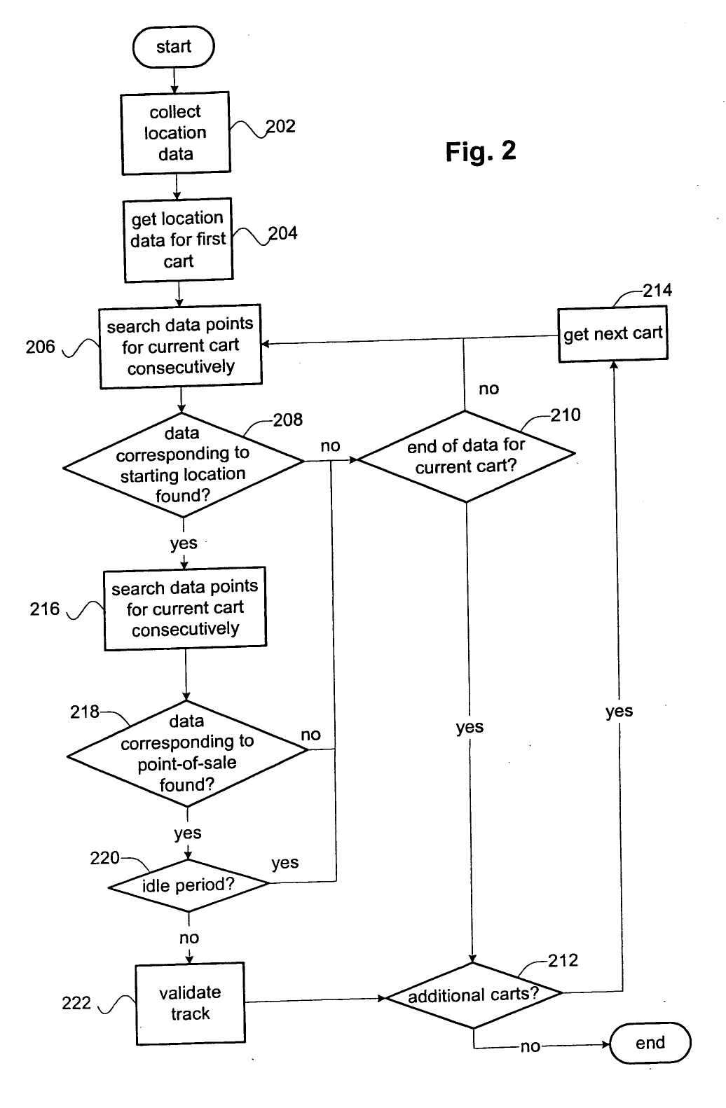

FIG. 2 is a flowchart 200 illustrating the generation of location and tracking data according to a specific embodiment of the present invention. This particular embodiment is described herein with reference to the store environment and data collection system of FIG. 1, but it will be understood that the process may be generalized beyond that embodiment. As carts 102 move through the store, the signature transmission of each is picked up and recorded by sensors 108 at various locations (202). At the end of the day, the location data generated by sensors 108 are received and processed by server 116 to identify valid and complete “tracks” followed by any of the carts. As will be understood, server 116 may be any of a wide variety of computing devices capable of performing the data processing described herein, may be situated locally or remotely, and may process location information from one or more facilities without departing from the scope of the present invention. The processing of the location data is accomplished as follows.

Location data corresponding to a first one of the carts are retrieved (204) and evaluated consecutively (206) to identify data corresponding to a predetermined starting location in the store (208), e.g., a shopping cart pick-up location. If such data are not identified, and the data for the current cart are exhausted (210), it is determined whether there are data corresponding to additional carts to be processed (212). If so, the data for the next cart are retrieved (214) and the process begins again (206). If not, the process ends.

If the location data for the current cart include starting location data (208), the data continue to be searched (216) for a data point corresponding to a point-of-sale (i.e., check out) location (218). If such a data point is found, and the cart was not idle for more than some predetermined period of time (220), the set of data points between the starting location found in 206 and the point-of-sale location found in 216 is designated as a valid track (222). This process is then performed for any additional carts (212, 214, et seq.).

However, if data corresponding to a point-of-sale are not identified (218), or there are any idle periods between the starting and point-of-sale location (220), the data for the current cart are exhausted (210), and it is determined there are data corresponding to additional carts to be processed (212), the data for the next cart are retrieved (214) and the process begins again (206). Once the location data for all carts have been processed (212) the process ends.

Thus, according to the specific embodiment described above with reference to FIG. 2, a valid track is one which begins in an expected area (i.e., cart pick-up), and in which the cart proceeded through check out, and did not sit idle for longer than some predetermined and programmable period of time, e.g., 15 minutes. The combination of these criteria are intended to eliminate invalid data which represent, for example, abandoned carts and carts which are being used by store personnel to restock products.

The cart tracking data generated as described above may be used with point-of-sale data (i.e., check out receipts), product delivery data, inventory data, and product placement data (i.e., physical locations of products) to understand how various store configurations affect consumer traffic and purchasing behavior. That is, store environment parameters which have an impact on the consumer's experience may be changed and the tracking data analyzed to determine the effect of each change. This analysis may be something as simple as introducing a new product display or rearranging products on a shelf and measuring the monetary effect at check out. The analysis of the tracking data could also be done using sophisticated mathematical models and statistical techniques.

As will be understood, many types of valuable information can be gleaned from the tracking data generated by the present invention. For example, one could compare any of a plurality of metrics before and after a change. Such metrics may include, but are not limited to, percentage changes in traffic, a number of people, time spent in aisle or at a particular store location, dollars spent, products purchased, etc. In addition, individual metrics may be compared across the data, e.g., traffic in aisle 1 versus aisle 2, dollars spent on product A on Sundays versus Saturdays, the number of people purchasing product A versus product B, the number of people spending over $50 dollars versus less than $20, etc. Some examples may be illustrative. In one example, the number of the customers going down the milk aisle on one day may be compared with the number of customers going down the milk aisle on another day after the addition of a “Got Milk?” sign. In another example, the average customer waiting time for a particular service location (e.g., the deli counter) may be measured before and after additional staff are added to the service location.

It will also be understood that any of these types of analysis may be done across multiple store environments as well as across multiple store formats. This is particularly true as the number of valid data points across such environments and formats grows. So, for example, data from one or more grocery stores may be used to evaluate one or more other grocery stores. Moreover, grocery store data may be used, for example, to evaluate one or more drug stores or some other form of retailer (e.g., mass merchant, warehouse club).

One way in which the individual effects of multiple changes to a store environment may be estimated is through the use of regression analysis. Regression analysis is a well known statistical analysis technique by which the extent to which each of a plurality of variables correlates with each of a plurality of outcomes is represented by a coefficient indicative of the strength of the correlation.

For example, aisle configuration or product display placement or type may be changed and the effect determined. Correlation with various ones of point-of-sale, product delivery, inventory, and product placement data for particular items allows determination of the bottom line effect of specific changes. Thus, for example, the monetary effect of making an aisle more efficient (i.e., less time spent by the consumer) vs. more engaging (i.e., more time spent by the consumer) can be measured. In other examples, other technologies are employed in combination with the techniques of the present invention. One such technology employs point-of-sale and product delivery data to estimate when a particular product will be out of stock. Another technology employs tags on individual products on the shelves which may be read to determine when specific products are out of stock. It will be understood that both of these technologies may be integrated with the techniques of the present invention project to provide data as to when a product is out of stock. This information can then be used to study the impact of traffic patterns to out of stocks and lost sales. As will be understood, such effects may be measured using techniques ranging from simple comparisons to manual or software controlled statistical analysis.

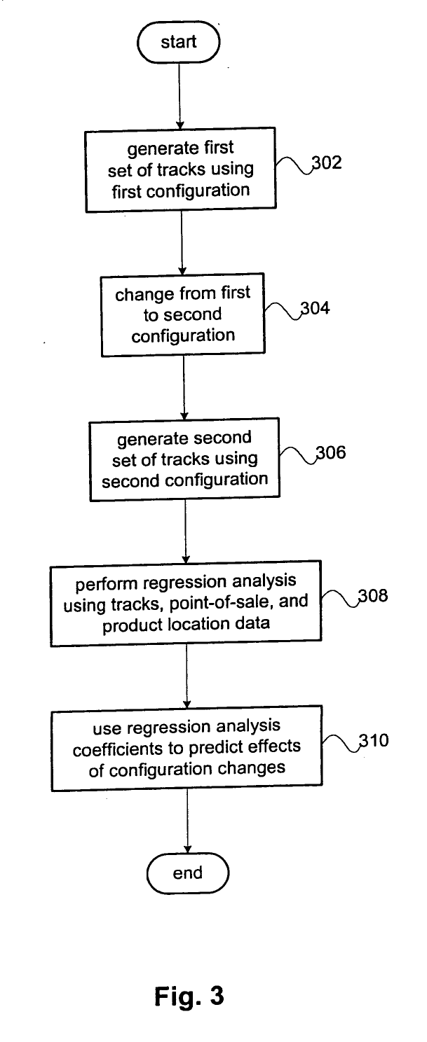

FIG. 3 is a flowchart 300 illustrating such a use of cart tracking data to determine the effects of changing store environment parameters according to a specific embodiment of the present invention. Initially, a first set of tracks is generated in a store environment characterized by a first configuration (302). These tracks may be generated in a variety of ways such as, for example, the specific process described herein with reference to FIG. 2. The physical configuration of the store is then altered (304). According to various embodiments, store environment parameters which may be changed or introduced include signage, end caps, special promotion areas, informational kiosks (e.g., health), store-within-a-store areas (e.g., baby products), shelf look and configuration, lighting, flooring (carpets, tile, cement), height of shelves, use of scents, aisle length, orientation, and configuration. Once the configuration is changed, a second set of tracks is generated in a manner similar to 302 (306).

A regression analysis is then performed which makes use of the tracking data generated in 302 and 306, as well as point-of-sale, product delivery, inventory, and product placement data (308). The coefficients generated in the regression analysis are then used to determine the effects of the configuration change on consumer behavior as well as to predict the effects of the changes of specific parameters (310). For example, beauty care products are typically carried by supermarkets whose market share in this area has steadily declined as other specialty retailers have beaten supermarkets in price. The present invention may be used, for example, to determine how the beauty care products area in a grocery store can be modified to compete more evenly with other retailers in this area who are more competitive on price. That is, in lieu of price, other parameters may be identified which make consumers more likely to buy such products in the grocery store.

The consumer tracking data generated by the present invention when correlated with the point-of-sale data and product placement data may be used to generate yet another aspect of the invention. That is, by gathering enough data and evaluating the effects of various environment parameter changes (e.g., using regression analysis), a store environment may then be created, simulated, and evaluated entirely in software. As discussed above, regression analysis is a statistically-based data processing technique which is used to evaluate multi-variable environments and which assigns a coefficient to each which represents its relative impact, i.e., how much of a measured change is attributable to each variable. For example, the effect of outside temperature on store traffic and the purchase of particular items may be determined.

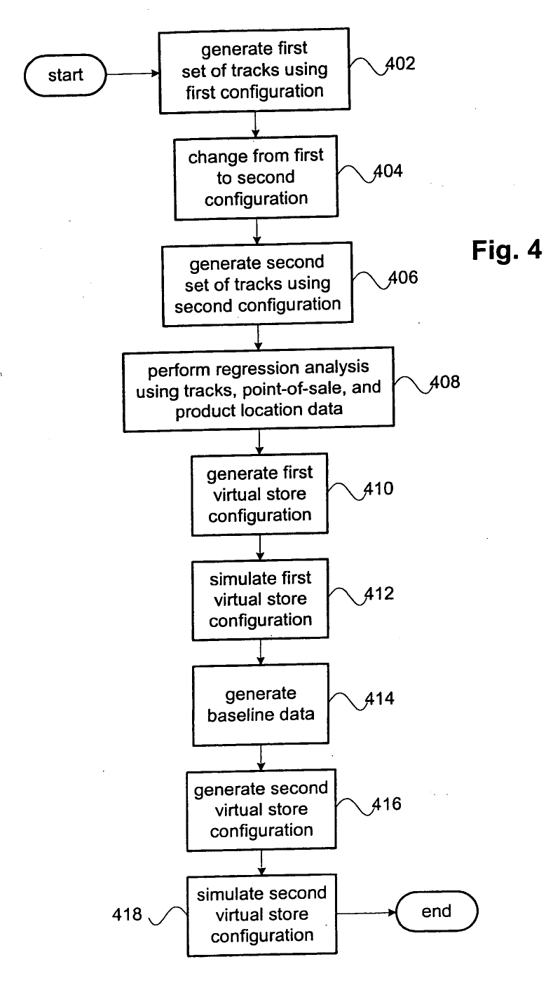

According to such an embodiment, a virtual store environment is presented in which any of a number of environment parameters for which the empirically generated tracking, point-of-sale, and product placement data have been collected and evaluated may be modified. A user may then modify specific parameters of interest to measure, for example, changes in traffic patterns and/or the resulting effect on sales of specific products. FIG. 4 is a flowchart 400 illustrating the generation of such a virtual store environment according to a specific embodiment of the present invention.

Initially, a first set of tracks is generated in a store environment characterized by a first configuration (402). As mentioned above with reference to FIG. 3, these tracks may be generated in a variety of ways such as, for example, the specific process described herein with reference to FIG. 2. The physical configuration of the store is then altered (404). The store environment parameters which may be changed are described above with reference to FIG. 3. Once the configuration is changed, a second set of tracks is generated in a manner similar to 402 (406).

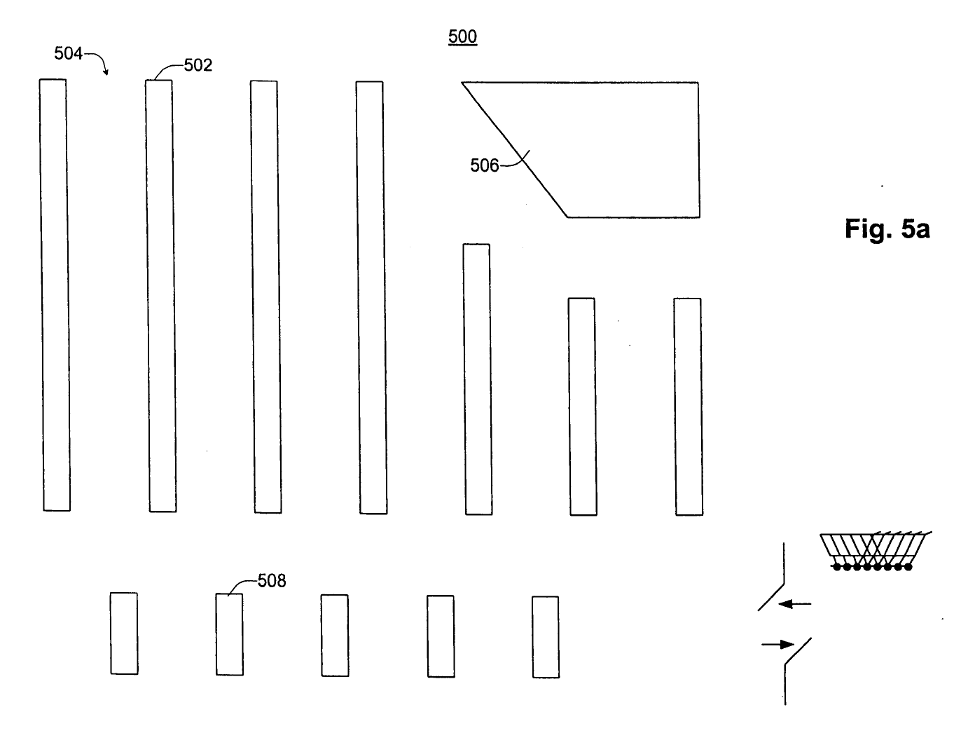

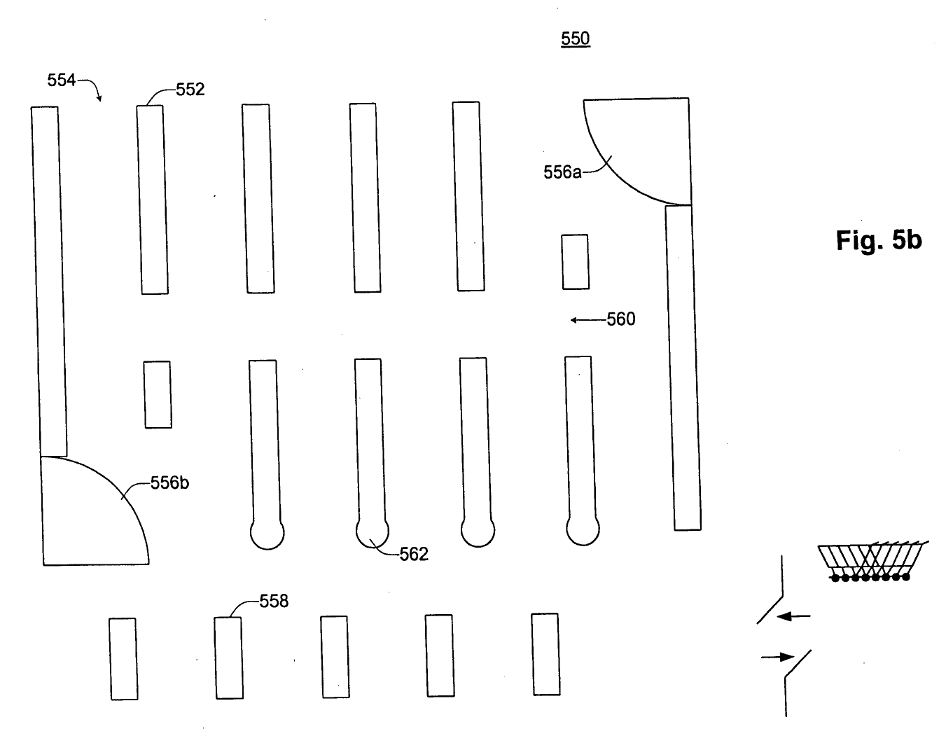

A regression analysis is then performed which makes use of the tracking data generated in 402 and 406, as well as point-of-sale, product delivery, inventory, and product placement data (408). The coefficients generated in the regression analysis are then used in a predictive manner to simulate consumer behavior in a virtual environment. That is, a first virtual store configuration is generated and corresponding visual representation is presented in a graphical user interface (410) as illustrated by the example store environment configuration 500 of FIG. 5a. Configuration 500 is shown with shelves 502, vertical aisles 504, service area 506 (e.g., deli or bakery), and check out lanes 508. It will be understood that the diagrams of FIGS. 5a and 5b are merely illustrative and that presentation of the store configuration may be achieved in any number of ways without departing from the scope of the present invention.

Referring again to FIG. 4, configuration 500 is simulated according to the coefficients generated in 408 (412). That is, consumer behavior in the virtual store represented by configuration 500 is simulated in accordance with the predictive tools generated from the actual consumer behavior tracked in 402 and 406. Baseline consumer behavior data are generated in this simulation (414) which may then be used for later comparison. Such baseline data may be desirable, for example, where configuration 500 corresponds to an actual physical store layout.

That is, configuration 500 may be modified to generate a second configuration 550 as shown in FIG. 5b (416). As can be seen when compared with configuration 500, similar elements are retained in configuration 550 (shelves 552, vertical aisles 554, service area 556a, check out lanes 558, etc.). However, the specific configurations of some of these elements have been changed. In addition, a central horizontal aisle 560, an additional service area 556b, and expanded circular end cap displays 562 have been introduced.

This second configuration may then be simulated according to the regression analysis coefficients (418). Each successive simulation may be analyzed in isolation or with reference to some baseline such as that described above with reference to 414.

Another way of tracking consumer movements in a store environment and generating tracks to be used as described above is to detect the heat signatures of individual consumers as they move through the store. Software techniques developed by IBM help to distinguish various heat signatures from each other and to generate a single continuous path. This technique also can provide a more accurate picture of the consumer's movement in that it can follow the consumer when he moves away from his cart as well as captures the movements of consumers without carts. Heat signature may also be used to determine exactly where a consumer is looking, i.e., which way she is facing, whether she is bending over or crouching down to look at a lower shelf, etc. According to a specific embodiment, such an approach is used in combination with the cart sensing technology described above to take advantage of the more detailed information available from heat signature tracking as well as to more reliably identify particular heat signature.

According to various embodiments and as will be understood, the present invention may scale from a single data collection site to multiple sites via networking technology. That is, instead of gathering data from a single site as described above with reference to FIGS. 1 and 2, data may be collected at multiple sites and transmitted to a single remote repository via the Internet. In this way, a greater number of data points can be accumulated in a shorter period of time, thus reducing development time for a virtual store simulation tool such as the one described above with reference to FIGS. 4, 5a and 5b. In addition, there is less of a need to change configurations of any one store to understand the effects of various configurations because the multiple site configurations may be compared to each other.

While the invention has been particularly shown and described with reference to specific embodiments thereof, it will be understood by those skilled in the art that changes in the form and details of the disclosed embodiments may be made without departing from the spirit or scope of the invention. That is, there are a lot of ways in which tracking data generated by the system described herein may be used to derive some bottom line benefit. For example, such information may be used to determine where a particular store should put particular resources and when it should put them there, thus potentially increasing revenues associated with those resources while simultaneously making the stocking of those resources more efficient (and thus less costly). Also, understanding consumer movements can result in additional benefits such as better traffic patterns and shorter queues.

In addition, the present invention may be augmented, for example, by incorporating technology which tracks which products consumers actually place in carts at particular times. Such an embodiment could be implemented, for example, by enabling each cart to sense products through any of a variety of means such as, for example, using RF identification tags on the products and sensors/receivers on the carts. This information could then be transmitted to a central server continuously or via periodic downloads. Such data could give an even more accurate picture of consumer behavior than merely identifying items in a cart from the final point-of-sale data. For example, such an embodiment could not only sense when a consumer places particular objects in the cart, but when items are removed and/or replaced by other items.

Moreover, the tracking data generated by the present invention may be analyzed in a variety of ways to derive desired information. That is, everything from simple comparisons to sophisticated mathematical techniques (including but not limited to regression analysis) may be employed to derive such information. Therefore, in view of the foregoing, the scope of the invention should be determined with reference to the appended claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for tracking a plurality of product containers in a store environment and generating a track through the store environment representative of a continuous path followed by each of the product containers to a point-of-sale location, the system comprising:
the plurality of product containers;
a plurality of identification tags each of which is associated with and uniquely identifies one of the product containers;
a plurality of sensors in the store environment each of which has a region associated therewith within which the identification tags are detected, at least one of the plurality of sensors having within its associated region the point-of-sale location; and
a processor configured to receive location data from the plurality of sensors and generate the track therefrom.

2. The system of claim 1 wherein the plurality of containers comprises at least one of shopping carts, shopping baskets, and shopping bags.

3. The system of claim 1 wherein the plurality of identification tags comprises active transmitters.

4. The system of claim 1 wherein the plurality of identification tags comprises detectable patterns.

5. The system of claim 1 wherein the detectable pattern comprises a UPC code.

6. The system of claim 7 wherein the passive sensors comprise at least one of infrared radiation detectors and radio frequency detectors.

7. The system of claim 1 wherein the plurality of sensors comprise active sensors for detecting patterns associated with the identification tags.

8. The system of claim 7 wherein the active sensors comprise UPC code scanners.

9. The system of claim 1 further comprising a plurality of heat detectors for detecting human heat signatures associated with the plurality of containers.

10. The system of claim 9 wherein the processor is further configured to use heat signature data from the heat detectors to generate the track.

11. The system of claim 1 wherein the plurality of sensors comprises at least one starting location sensor associated with a starting region in the store environment, the track being considered valid only where the track begins in the starting region.

12. A computer-implemented method for determining effects of changing parameters in a store environment, comprising:
generating a first plurality of tracks through the store environment, each of the first plurality of tracks being representative of a continuous path followed by each of a first plurality of product containers to a point-of-sale location before one or more store environment parameters is changed;
generating a second plurality of tracks through the store environment, each of the second plurality of tracks being representative of a continuous path followed by each of a second plurality of product containers to a point-of-sale location after the one or more store environment parameters is changed; and
analyzing the first and second plurality of tracks to determine relationships between the one or more store environment parameters and one or more of the effects.

13. A database comprising data corresponding to tracks through a store environment, each track being representative of a continuous path followed by each of a plurality product containers, the tracks being generated from location data for each of the plurality of product containers using a plurality of sensors, each track being generated from the location data only where the location data for the corresponding product container satisfies at least one validity criterion.
